(19) United States
(12) Patent Application Publication
(10) Pub. No.: US 2007/0208577 A1
(43) Pub. Date: Sep. 6, 2007

(54) Position common object

(76) Inventors: Maria Theresa Barnes Leon, Fremont, CA (US); Nardo B. Catahan JR., S. San Francisco, CA (US); Caroline Muralitharan, San Jose, CA (US); Darayush Mistry, Sunnyvale, CA (US); Prasad Gune, San Francisco, CA (US)

Correspondence Address: CSA LLP, 4807 SPICEWOOD SPRINGS RD., BLDG. 4, SUITE 201, AUSTIN, TX, 78759, US

(21) Appl. No.: 10/751,011

(22) Filed: Dec. 31, 2003

Related U.S. Application Data
(60) Provisional application No. 60/457,494, filed on Mar. 24, 2003.

(51) Int. Cl. G06Q 10/00; G06Q 30/00

(52) U.S. Cl. 705/1

(57) ABSTRACT

Stored employee position management information in a first format for use by a first computerized system is transformed to readily make the stored employee position management information available for use in a second computerized system that utilizes a second format in a cost-efficient and time-efficient manner.

### CROSS REFERENCE TO RELATED APPLICATIONS

This application claims the benefit of U.S. Provisional Patent Application No. 60/457,494 filed March 24, 2003, entitled, “POSITION COMMON OBJECT,” by Barnes-Leon et al., and which is hereby incorporated by reference in its entirety.

### TECHNICAL FIELD

The present invention is directed to the field of data modeling in the context of employee relationship management, and more specifically to aspects of employee position data management.

### BACKGROUND

An enterprise may employ various systems to manage various aspects of human resources and enterprise resources. The various systems can include Human Resource Management (HRM) systems, Employee Relationship Management (ERM) systems, Enterprise Resources Planning (ERP) systems, and custom applications for the purpose of sharing employee position data.

These various systems need to communicate data to each other. However, the users of human resource management system in the back-office typically store data in forms usable by the back-office computerized system, which often differ significantly from the forms usable with front-office computerized systems such as employee relationship management systems.

Thus, when some or all aspects of employee position information are managed by both back-office and front-office computerized systems, there is a need to synchronize the employee position information in both computerized systems.

Certain approaches utilize a “point to point” data mapping between the various systems that manage human resources and enterprise resources. In other words, an interface must be created between any two applications for transferring data between the two applications. This results in the creation of myriad interfaces. For example, if there are six applications and each of the applications needs to communicate employee data with each of the other five applications, then the number of interfaces that need to be created is 15. Further, if the communication between such applications are bidirectional, then the number of interfaces can be as many as 30. Further, the disadvantage of such approaches is that the interfaces must be re-created for every system that needs to be corrected or modified.

Thus, in order for front-office computerized systems to communicate with back-office computerized systems that are already being used, the user must manually regenerate data from the back-office computerized systems in forms usable by the front-office computerized systems. Such manual regeneration has several significant disadvantages, including: (1) it is often expensive; (2) it often requires a substantial amount of time to complete; (3) it must be repeated each time data changes in either the back-office system or the front-office system; and (4) it is prone to errors.

In view of the foregoing, an automated approach for transforming data used by a back-office computerized system for use by a front-office computerized system, or vice versa, is needed.

### BRIEF DESCRIPTION OF THE DRAWINGS

FIG. 1A is a high-level network diagram showing aspects of a computerized environment in which the facility operates, according to certain embodiments.

FIG. 1B is a block diagram showing some of the components typically incorporated in at least some of the computer systems and other devices on which the facility executes.

FIG. 2 is a high-level flow diagram that shows some steps performed by the facility.

FIG. 3 is a data structure diagram that illustrates the employee position common object model, according to certain embodiments.

### DETAILED DESCRIPTION

All changes in the employee position management information need to be captured and made accessible to all relevant computer applications in the employee data management system. Thus, a common data storage model is needed for enabling users who either use or manage employee position information to have the same view of the employee position information across the various computer applications.

According to certain embodiments, the employee position common object provides a defined data structure that can be used as a conduit for passing information associated with employee positions from one computerized system to another. Such a data structure is a common structure that can be mapped to multiple distinct enterprise systems purchased from different vendors. It solves the problem of linking human resource management systems to employee relationship management systems, enterprise resources planning systems, and custom applications for the purpose of sharing employee position data.

Employee position information and employee position codes are important aspects of employee administration, as they provide the basis for creating organizational hierarchies. Employees are linked with employee positions and/or employee position codes. Thus, representations of an organization can be created based on employee positions rather than individual employees.

The list of positions and employee position codes will be maintained within the back-office system, such as an HRM and is likely to change periodically. Thus, the front-office ERM system needs to synchronize the employee position information with the back-office system in order to obtain the latest information, for example.

Assuming that the front-office system is an HRM system and the back-office system is an ERM system, the following process flow is one of many ways that a system integration process can query employee position information and employee position code data from the back-office system to the front-office system.
1. The administrator defines the appropriate fields in ERM (employee position information and employee position code) that need to be updated with the master data from the external HRM back-office system.
2. The administrator sets up a batch process to trigger an automatic data synchronization process periodically.
3. When such a data synchronization process is triggered, the integration server will initiate an automated computerized business service to extract the employee position information and employee position code data from the HRM back-office. The extracted data may be packaged into an XML file. The XML file includes the employee position information and employee position code data and any necessary header information, encryption data, and digital signatures.
4. The XML file is sent to the ERM system over HTTP.
5. The integration process then waits for an Acknowledgement. The Acknowledgement message is unpackaged and the acknowledgement is verified. If an acknowledgement is not received after 2 hours the entire process is aborted. In practice, this timeout will be much shorter (a few seconds to a few minutes) depending on the volume of employee position and position code data.
6. The integration process then imports the selected master data into the ERM database.
7. The Integration Server will create a Receipt Acknowledgement Message.
8. The Confirmation Message is returned to the originating application and the message status is updated in the originating database.

When employee position management information is passed from the back-office employee position management system to the front-office employee position management system, then the back-office employee position management system is referred to as the source system and the front-office employee position management system is referred to as the target system. On the other hand, when employee position management information is passed from the front-office employee position management system to the back-office employee position management system, then the front-office employee position management system is referred to as the source system and the back-office employee position management system is referred to as the target system.

A software facility (hereafter “the facility”) for automatically converting employee position management information, is described. In some embodiments, the facility converts employee position management information from a form used by the source system to a form used by the target system.

In some embodiments, such as embodiments adapted for converting employee position management information in the first source format, the facility converts employee position management information by converting the employee position management information that is in the first source format into an intermediate format. The intermediate format is then used to convert the employee position management information into the target format.

By performing such conversions, embodiments of the facility enable a user of a first computerized system who has stored employee position management information in a first format for use by the first computerized system to readily make the stored employee position management information available for use in a second computerized system that utilizes a second format in a cost-efficient and time-efficient manner.

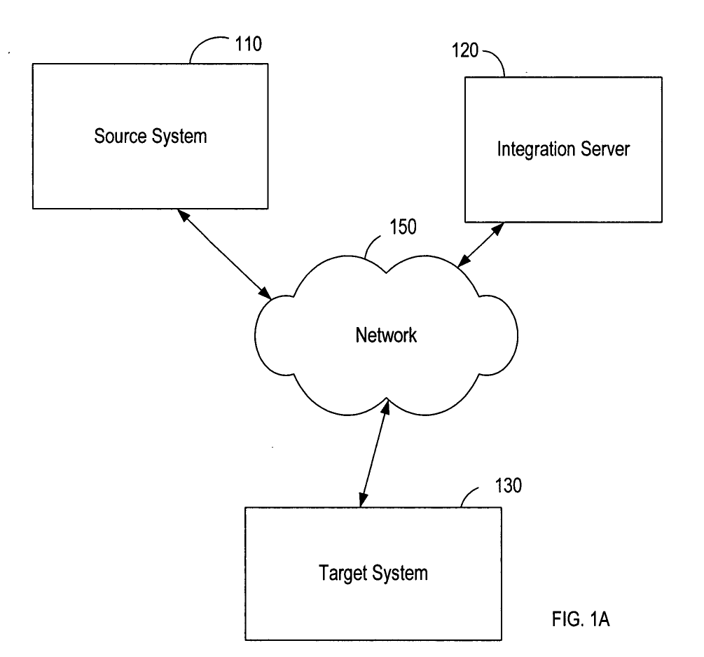

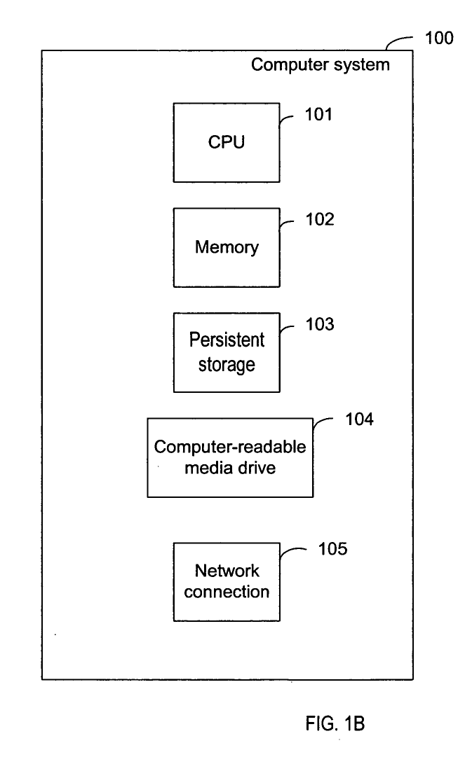

FIG. 1A is a high-level network diagram showing aspects of a typical hardware environment in which the facility operates. FIG. 1A shows a source system 110, a target system 130, an integration server 120 and a network 150. Source system 110 stores employee position management information in a source format. There may be more than one source system. Target system 130 stores employee position management information in a target format. There may be more than one target system.

The facility (not shown) converts some or all employee position management information that is in the source format into the target format by using an intermediate format of the employee position management information. In certain embodiments, such conversions are performed with the aid of one or more other computer systems, such as integration server system 120. Components of the facility may reside on and/or execute on any combination of these computer systems, and intermediate results from the conversion may similarly reside on any combination of these computer systems.

The computer systems shown in FIG. 1A are connected via network 150, which may use a variety of different networking technologies, including wired, guided or line-of-sight optical, and radio frequency networking. In some embodiments, the network includes the public switched telephone network. Network connections established via the network may be fully-persistent, session-based, or intermittent, such as packet-based. While the facility typically operates in an environment such as is shown in FIG. 1A and described above, those skilled in the art will appreciate the facility may also operate in a wide variety of other environments.

FIG. 1B is a block diagram showing some of the components typically incorporated in at least some of the computer systems and other devices on which the facility executes, including some or all of the server and client computer systems shown in FIG. 1A. These computer systems and devices 100 may include one or more central processing units (“CPUs”) 101 for executing computer programs; a computer memory 102 for storing programs and data—including data structures—while they are being used; a persistent storage device 103, such as a hard drive, for persistently storing programs and data; a computer-readable media drive 104, such as a CD-ROM drive, for reading programs and data stored on a computer-readable medium; and a network connection 105 for connecting the computer system to other computer systems, such as via the Internet, to exchange programs and/or data—including data structures. While computer systems configured as described above are typically used to support the operation of the facility, those skilled in the art will appreciate that the facility may be implemented using devices of various types and configurations, and having various components.

It will be understood by those skilled in the art that the facility may transform employee position management information from a number of different source systems and from a number of different source software packages to a number of target systems and/or to a number of target software packages.

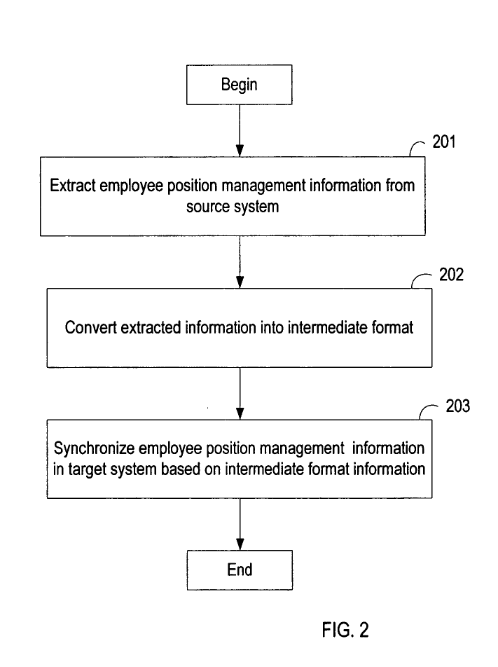

FIG. 2 is a high-level flow diagram that shows some steps typically performed by the facility in order to convert employee position management information from one or more source formats to the target format. At block 201, the facility extracts employee position management information from one or more source systems. At block 202, the facility converts the extracted information into an intermediate format. The intermediate format is described in greater detail herein, with reference to the common object data model. At block 203, the facility synchronizes the employee position management information from the source system with that of the target system by converting the employee position management information in intermediate format into the target format. After block 203, the steps as shown in FIG. 2 conclude.

The common object data model for employee position management may include the following information, according to certain embodiments:
Employee position Name
Employee position Description
Employee position Identifier (different from employee position name)
Related employee position organization
Related employee position division
Related parent employee position

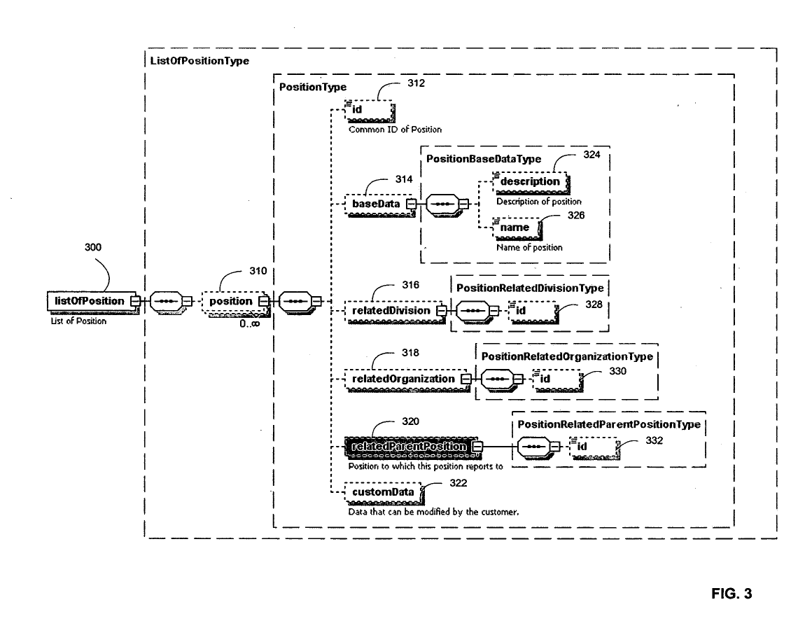

The common object data model for employee position management is herein referred to as an employee position common object model. FIG. 3 is a data structure of the employee position common object model associated with employee data management, according to certain embodiments. Such an employee position common object model illustrates a sample intermediate data structure that can be produced from corresponding employee position management information in the source format. The elements and associated sub-elements in the employee position data structure model as described herein are optional. In other words, the decision to include a given element or sub-element may vary from implementation to implementation. Further, the employee position common object model is designed to be flexible and thus, the definition of a given element or sub-element may vary form implementation to implementation depending of the needs of the enterprise.

The employee position common object model as described herein may be adapted and/or extended to represent various employee position information for most industries.

In FIG. 3, the intermediate data structure used by the facility is represented by a listOfPosition element 300, which may include any number of position elements 310.

Each position element 310 may include a position identifier (ID) element 312, a position baseData element 314, a position relatedDivision element 316, a position relatedOrganization element 318, a relatedParentPosition element 320, and a position customData element 322.

The position baseData element 314 contains basic data that is associated with the given employee position. The position baseData element 314 includes a position description element 324 that is a description of the. given employee position. The position baseData element 314 also includes a position name element 326.

The position relatedDivision element 316 is the division within the enterprise under which the given employee position appears. The position relatedDivision element 316 includes a position related division identifier (ID) element 328. For example, if the employee position is that of a “sales manager”, then the related division is “marketing division.”

The position relatedOrganization element 318 contains information that identifies which organization within the enterprise the given employee position appears. The position relatedOrganization element 320 includes a position related organization identifier (ID) element 330. For example, the enterprise may have several sales organization.

The relatedParentPosition element 320 is the employee position to which the given employee position reports. The relatedParentPosition element 320 includes a related parent position identifier (ID) element 332.

The customData element 322 is for data that can be used by the user for customizing the employee position data structure to track any other employee position information that the user desires.

It will be appreciated by those skilled in the art that the above-described facility may be straightforwardly adapted or extended in various ways. For example, the facility may be used to transform various other kinds of inventory transaction information, and may be used to transform inventory transaction information between a variety of other formats.

In the foregoing specification, embodiments of the invention have been described with reference to numerous specific details that may vary from implementation to implementation. Thus, the sole and exclusive indicator of what the invention is and what is intended by the applicants to be the invention, is the set of claims that issue from this application, in the specific form in which such claims issue, including any subsequent correction. Any express definitions set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

We claim:

1. A method in a computing system for managing employee data, the method comprising:
extracting employee position management information in a first form that is associated with a first source computerized employee position management system;
converting the employee position management information in the first form into employee position management information that is in a second intermediate form; and
converting the employee position management information in the second intermediate form into employee position management information in a target form that corresponds to a target computerized employee position management system.

2. The method of claim 1, further comprising:
using the employee position management information in the target form to perform at least one computer-implemented act from a set of computer-implemented acts comprising:
creating a new employee position record in the target computerized employee position management system; and
updating an existing employee position management record in the target computerized employee position management system.

3. The method of claim 1, further comprising:
extracting employee position management information in a third form that is associated with a second source computerized employee position management system that is distinct from the first source computerized employee position management system;
converting the employee position management information in the third form into employee position management information that is in the second intermediate form;
converting the employee position management information in the second intermediate form into employee position management information in the target form; and
using the employee position management information in the target form to perform at least one computer-implemented act from a set of computer-implemented acts comprising:
creating a new employee position management record in the target computerized employee position management system; and
updating an existing employee position management record in the target computerized employee position management system.

4. The method of claim 1, wherein the second intermediate form includes a list of employee positions element for defining a hierarchy of data elements, wherein the hierarchy of data elements includes a plurality of employee position elements, which include other elements.

5. The method of claim 4, wherein each of the plurality of employee position elements includes one or more elements selected from a group comprising:
a position identifier;
a position base data element;
a position related division element
a position related organization element;
a related parent position element; and
a position custom data element.

6. The method of claim 5, wherein the position base data element includes one or more elements selected from a group comprising:
a position description element; and
a position name element.

7. The method of claim 5, wherein the position related division element includes a position related division identifier.

8. The method of claim 5, wherein the position related organization element includes a position related organization identifier.

9. The method of claim 5, wherein the related parent position element includes a related parent position identifier.

10. A computer-readable medium carrying one or more sequences of instructions for managing employee data, wherein execution of the one or more sequences of instructions by one or more processors causes the one or more processors to perform:
extracting employee position management information in a first form that is associated with a first source computerized employee position management system;
converting the employee position management information in the first form into employee position management information that is in a second intermediate form; and
converting the employee position management information in the second intermediate form into employee position management information in a target form that corresponds to a target computerized employee position management system.

11. The computer-readable medium of claim 10, further comprising:
using the employee position management information in the target form to perform at least one computer-implemented act from a set of computer-implemented acts comprising:
creating a new employee position record in the target computerized employee position management system; and
updating an existing employee position management record in the target computerized employee position management system.

12. The computer-readable medium of claim 10, further comprising:
extracting employee position management information in a third form that is associated with a second source computerized employee position management system that is distinct from the first source computerized employee position management system;
converting the employee position management information in the third form into employee position management information that is in the second intermediate form;
converting the employee position management information in the second intermediate form into employee position management information in the target form; and
using the employee position management information in the target form to perform at least one computer-implemented act from a set of computer-implemented acts comprising:
creating a new employee position management record in the target computerized employee position management system; and
updating an existing employee position management record in the target computerized employee position management system.

13. The computer-readable medium of claim 10, wherein the,second intermediate form includes a list of employee positions element for defining a hierarchy of data elements, wherein the hierarchy of data elements includes a plurality of employee position elements, which include other elements.

14. The computer-readable medium of claim 13, wherein each of the plurality of employee position elements includes one or more elements selected from a group comprising:
a position identifier;
a position base data element;
a position related division element
a position related organization element;
a related parent position element; and
a position custom data element.

15. The computer-readable medium of claim 14, wherein the position base data element includes one or more elements selected from a group comprising:
a position description element; and
a position name element.

16. The computer-readable medium of claim 14, wherein the position related division element includes a position related division identifier.

17. The computer-readable medium of claim 14, wherein the position related organization element includes a position related organization identifier.

18. The computer-readable medium of claim 14, wherein the related parent position element includes a related parent position identifier.

19. A data structure for managing employee data, the data structure comprising a list of employee positions element for defining a hierarchy of data elements, wherein the hierarchy of data elements includes a plurality of employee position elements, which include other elements.

20. The data structure of claim 19, wherein each of the plurality of employee position elements includes one or more elements selected from a group comprising:
a position identifier;
a position base data element;
a position related division element
a position related organization element;
a related parent position element; and
a position custom data element.

21. The data structure of claim 20, wherein the position base data element includes one or more elements selected from a group comprising.
a position description element; and
a position name element.

22. The data structure of claim 20, wherein the position related division element includes a position related division identifier.

23. The data structure of claim 20, wherein the position related organization element includes a position related organization identifier.

24. The data structure of claim 20, wherein the related parent position element includes a related parent position identifier.
